(19) United States
(12) Patent Application Publication
(10) Pub. No.: US 2017/0138778 A1
(43) Pub. Date: May 18, 2017

(54) Horn antenna

(71) Applicant: VEGA GRIESHABER KG, Wolfach (DE)

(72) Inventors: Johannes Falk, St. Georgen (DE); Klaus Kienzle, Zell a.H. (DE); Fritz Lenk, Schiltach (DE); Roland Baur, Konigsfeld (DE)

(21) Appl. No.: 15/340,119

(22) Filed: Nov. 1, 2016

(30) Foreign Application Priority Data
Nov. 13, 2015 (EP) 15 194470.9

(51) Int. Cl. G01F 23/284; H01Q 1/22; F16J 15/02; H01Q 13/02

(52) U.S. Cl. CPC G01F 23/284; H01Q 13/02; H01Q 1/225; F16J 15/022

(57) ABSTRACT

A horn antenna for a radar measuring device, particularly a radar level gauge, with an antenna horn emitting at the front in a primary direction of emission, a rear feed device, and a filling, which at least partially fills the horn antenna and seals it at the front, with at least one seal being arranged between the filling and the antenna horn, with the seal being arranged in a radial direction perpendicular in reference to the primary direction of emission of the horn antenna at least partially outside the antenna horn or an extension of the antenna horn.

### CROSS REFERENCE TO RELATED APPLICATIONS

This patent application claims priority to European Patent Application 15 194470.9, filed on Nov. 13, 2015.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention relates to a horn antenna.

2. Background of the Invention

Radar measuring devices are known from prior art, particularly radar level gauges, which based on the principle of acoustical logging detect a fill level of a fill good located in a container, particularly liquids and bulk goods. Such radar level gauges are equipped with horn antennas, for example, by which a coupled HF-signal is emitted in the direction of the fill good and is reflected thereby. In a combined transceiver system of the radar level gauge the microwave pulses reflected by the fill good are detected and by way of measuring the elapsed time of said pulses a distance is determined from the fill level gauge to the fill good.

In general, horn antennas show a simple and robust design, very good effectivity, and they can be produced in a cost-effective fashion. However, as soon as the interior of the antenna horn becomes soiled, this has negative effects upon the performance of the horn antenna.

Therefore it is known from prior art to protect the antennas of such fill level gauges from soiling and/or corrosion caused by aggressive measuring environments. This is achieved for example by covering the antennas at the front with a blister or to fill the horn with a medium, e.g., synthetic material.

Although covering the horn antenna with a blister is able to keep soiling and aggressive media from the antenna horn, however such horn antennas are still not suitable for the use in pressurized environments or in a vacuum.

Accordingly, in prior art there are horn antennas in which the antenna horn is filled completely with a solid medium, e.g., a synthetic material. Here, a gap between the antenna horn and the filling must be sealed in a pressure-tight fashion in order to prevent any undesired media from penetrating in the feed direction and reaching the electronics. In prior art usually O-rings are used as seals between the antenna horn and the dielectric in the area of the antenna at the front in a primary direction of emission. However, inside the antenna these O-rings generate reflections of the electromagnetic waves fed therein, which reflect a portion of the inserted energy back to the source, for example a hollow conductor, resulting in worsened return loss and thus lower antenna yields. Accordingly the effectiveness of the antenna is reduced.

The reflected energy generates a so-called pseudo-echo in the radar device, which leads to increased antenna ringing.

It has been acknowledged that the reason for this type of reflections is caused primarily in the different dielectricity values between the O-ring and the filler of the antenna horn, and thus the material of the O-ring is directly of influence upon the characteristic of the antenna. If different seals and/or O-rings are used for various purposes of the antenna here the performance of the antenna changes. This is considered disadvantageous.

The objective of the present invention is to further develop an antenna known from prior art such that any antenna ringing is minimized to the extent possible and undesired reflections inside the antenna are eliminated. Further, any sensitivity shall be prevented of the antenna towards various materials of the seals.

This objective is attained in a horn antenna as described herein.

### BRIEF SUMMARY OF THE INVENTION

In a preferred embodiment, a horn antenna (1) for a radar measuring device, particularly a radar level gauge, with an antenna horn (3) emitting at the front in a primary direction of emission, a feed device (5) at the rear, and a filling (7), which at least partially fills the horn antenna (1) and seals it at the front, with between the filling (7) and the antenna horn (3) at least one seal (9) being arranged, characterized in that the seal (9) is arranged in a radial direction (R) perpendicular in reference to the primary direction of emission (HA) of the horn antenna (1) at least partially outside the antenna horn (3) or an extension (V) of the antenna horn (3).

In another preferred embodiment, a horn antenna (1) as described herein, characterized in that the seal (9) is embodied as an O-ring (91, 92).

In another preferred embodiment, a horn antenna (1) as described herein, characterized in that the seal (9) is arranged in a groove (71, 72, 31, 32).

In another preferred embodiment, a horn antenna (1) as described herein, characterized in that the antenna horn (3) comprises at least in the proximity of the seal (9) an attachment (11) pointing outwardly in the radial direction (R).

In another preferred embodiment, a horn antenna (1) as described herein, characterized in that the attachment (11) is embodied as a step (11) projecting outwardly in the radial direction (R) comprising a circumferential collar (12) and/or a circumferential groove (31, 32, 33) extending in the primary direction of emission (HA).

In another preferred embodiment, a horn antenna (1) as described herein, characterized in that the filling (7) comprises in the proximity of the seal (9) a groove (71, 72) for at least partially accepting the seal (9).

In another preferred embodiment, a horn antenna (1) as described herein, characterized in that a circumferential centering ring (15) is arranged between the antenna horn (3) and the filling (7).

In another preferred embodiment, a horn antenna (1) as described herein, characterized in that the centering ring (15) is embodied as an O-ring (91, 92).

In another preferred embodiment, a horn antenna (1) as described herein, characterized in that the centering ring (15) is arranged in a circumferential third groove (33) of the antenna horn (3).

In another preferred embodiment, a horn antenna (1) as described herein, characterized in that at least two O-rings (91, 92) are arranged in a frontal section in the primary direction of emission (HA) and one centering ring (15) in a rear section in a primary direction of emission (HA).

### BRIEF DESCRIPTION OF THE DRAWINGS

FIG. 1 is a line drawing evidencing a perspective illustration of a longitudinal section in the primary direction of emission of a first exemplary embodiment of a horn antenna.

FIG. 2 is a line drawing evidencing an alternative embodiment of an area of the horn antenna of FIG. 1 located in the front in the primary direction of emission.

FIG. 3 is a line drawing evidencing an alternative embodiment of a section of the horn antenna of FIG. 1 located in the rear in the primary direction of emission.

FIG. 4 is a line drawing evidencing a visualization of the effects yielded by the measures taken in the present invention upon the propagation of electromagnetic waves.

### DETAILED DESCRIPTION OF THE INVENTION

A horn antenna according to the invention for a radar measuring device, particularly a radar level gauge, comprises an antenna horn, emitting radiation in a frontal direction, a rear feeding device, and a filling, which at least partially fills the horn antenna and seals it towards the front, with at least one seal being arranged between the filling and the antenna horn. A horn antenna according to the invention is characterized in that the seal is arranged in a radial direction perpendicular in reference to the primary direction of emission of the horn antenna, at least partially outside the antenna horn, or a virtual extension of the antenna horn. Due to the fact that the electromagnetic waves coupled in the horn antenna typically propagate inside the filling, which is usually made from a dielectric material, with the direction of propagation normally being predetermined by a conical design of the antenna horn, by an arrangement of the seals at least partially outside the antenna horn and/or outside an extension of the antenna horn here a more distinct function can be yielded of the reflections generated by the boundary between the material of the filling and the material of the seal.

Ideally the seals are arranged completely outside a contour of the antenna horn, so that such reflections can be completely avoided at a boundary between the filling and the seal.

Here it shall be mentioned that in the sense of the present application an arrangement of the seal at least partially outside the antenna horn or an extension of the antenna horn shall be understood such that the seal is arranged at least partially outside a linear extension or, in case of an interruption of the contour of the antenna horn, partially outside a linear extension of this contour.

In principle, any suitable material can be used as a gasket for sealing the gap between the antenna horn and the filling. However, a particularly simple embodiment can be achieved when the seal is embodied as an O-ring, because such O-rings are freely available in the market in a plurality of embodiments and materials.

An arrangement of the seal predetermined in reference to the antenna horn and the filling as well as a clever arrangement outside the antenna horn and/or an extension of the antenna horn can be yielded when the seals are arranged in a groove. Such a groove may be provided for example in the antenna horn and/or the filling.

For example, in the proximity of the seal the antenna horn may at least show an attachment pointing outwardly in a radial direction. Such an attachment can be embodied for example as a step projecting outwardly in the radial direction with a circumferential collar and/or a circumferential groove extending in the primary direction of emission. By such attachments, using simple means an accepting seat can be generated for one or more seals, which in the sense of the present invention is arranged outside the antenna horn and/or a virtual extension or continuation of the antenna horn.

By a step projecting outwardly further a mechanic support of the filling can be yielded and thus increased strength of the antenna overall can be insured to resist pressures.

Additionally or alternatively in the proximity of the seal the filling may show a groove for an at least partial acceptance of the seal. This may be advantageous, for example, when the antenna horn shows an attachment projecting outwardly in the area at the front in the primary direction of emission, which is also filled with the material of the filling, however is located outside a virtual extension of the antenna horn. A groove for accepting the seal may be arranged in such an area of the filling so that a sealing arrangement can be yielded in a simple fashion.

A circumferential centering ring may further be arranged between the antenna horn and the filling in order to ensure an arrangement of the filling inside the antenna horn as symmetrical and centered as possible. The centering ring may also be arranged in a groove of the antenna horn projecting outwardly, with the centering ring perhaps being embodied as an O-ring as well to ensure a simple design.

In order to ensure a centered coupling of the electromagnetic waves in the filling, here the centering ring can be arranged for example in an end section of the filling facing the feed. This way it is ensured that this filling is aligned in a centered fashion in reference to the feed.

### DETAILED DESCRIPTION OF THE FIGURES

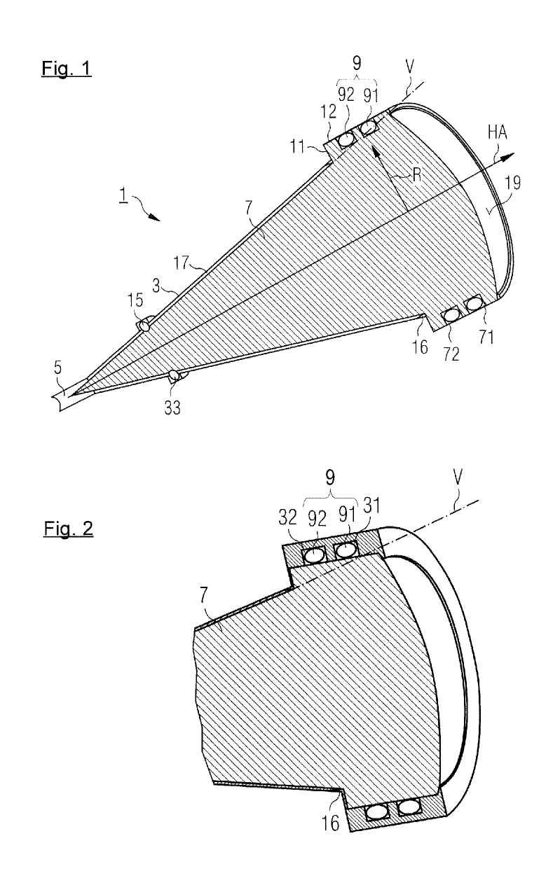

FIG. 1 shows a perspective illustration of a horn antenna 1 in a longitudinal section in the primary direction of emission HA. An antenna horn 3 of the horn antenna 1 is essentially embodied as a conically designed metallic jacket, at which in the primary direction of emission HA at the front a step 11, projecting outwardly, is arranged with a circumferential collar 12 extending in the primary direction of emission HA. By the step 11 projecting outwardly and the collar 12 here a cylindrical section is formed at the front of the antenna horn 3, which in the present exemplary embodiment, similarly to the antenna horn 3, is almost completely filled with a filling 7. The filling 7 is embodied conically at the rear area seen in the primary direction of emission HA, with an apex extending in the direction of a feed device 5, formed at the rear at the horn antenna 1, at the front of a hollow conductor.

At the front in the primary direction of emission HA the filling 7 comprises a convexly shaped exposed surface 19, which contributes by a lens-effect to the directional characteristic of the horn antenna 1. The filling 7 is circumferentially sealed towards the circumferential collar 12 via a first O-ring 91 and a second O-ring 92, which in the present exemplary embodiment are arranged in two circumferential grooves 71, 72 arranged in the filling 7. Both the two grooves 71, 72 as well as the O-rings 91, 92 arranged therein, as indicated in the illustration of FIG. 1, are arranged at least partially outside a linear extension V of the antenna horn 3. In the present exemplary embodiment the first O-ring 91 is arranged by approximately 50% outside said extension V and the second O-ring 92 is arranged completely outside the extension V, so that the reflections of electromagnetic waves are considerably reduced at a boundary between the filling 7 and the O-rings 91, 92.

By the step 11 it is further achieved that the filling 7 is provided in the rear direction with a circumferential reinforcement, allowing to yield increased pressure resistance of the horn antenna 1.

In order to yield a centered alignment of the filling 7 in reference to the feed device 5 embodied as a hollow conductor, further a circumferential centering ring 15 is arranged between the antenna horn 3 and the filling 7, which in the present exemplary embodiment is also embodied as an O-ring. In order to also reduce reflections at this centering ring 15 or to avoid it entirely, if possible, the centering ring 15 comprises a third groove 33 of the antenna horn 3 projecting radially outwardly, so that the centering ring 15 is also at least partially distanced from the area of propagation of the electromagnetic waves. In order to ensure a correct alignment of the filling 7 inside the antenna horn 3, in the present exemplary embodiment a centering brace 16, projecting circumferentially inwardly, is provided at the transition between the antenna horn 3 to the step 11 projecting radially outwardly, which adjusts a distance between the filling 7 and the antenna horn 3 in a frontal section of the horn antenna 1.

FIG. 2 shows an alternative embodiment of a frontal section of the horn antenna 1 of FIG. 1.

The alternative embodiment of FIG. 2 shows the circumferential collar 12 with an increased wall thickness so that the first groove 31 and the second groove 32 may be provided circumferentially in the collar 12 to accept the first O-ring 91 and the second O-ring 92.

This way the material of the filling 7 can be embodied at this point without any grooves, allowing a further reduction of potential boundary reflections. Contrary to the exemplary embodiment shown in FIG. 1, according to FIG. 2 both O-rings 91, 92 are arranged outside an extension V of the antenna horn 3 such that here a particularly effective reduction of interferences can be yielded. FIG. 2 shows once more clearly the circumferential centering brace 16 which ensures an alignment of the filling 7 in reference to the antenna horn 3 in the frontal area.

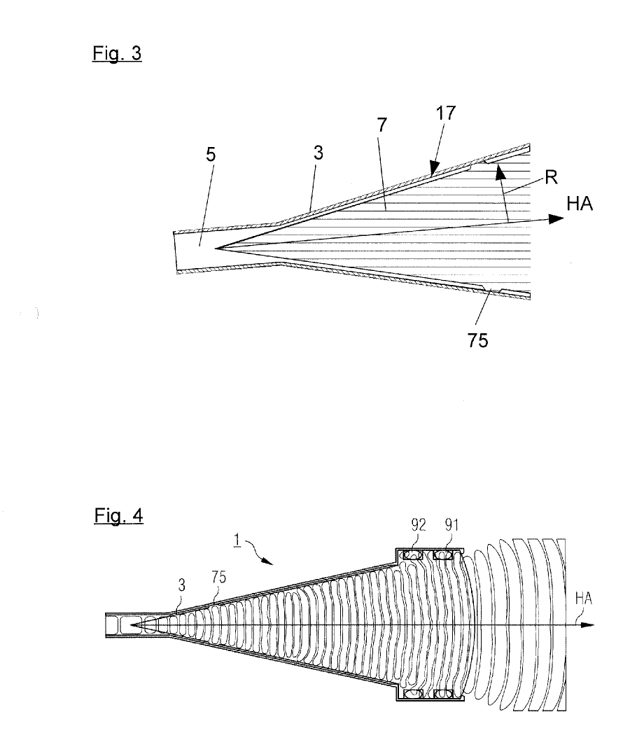

FIG. 3 shows an alternative embodiment of a rear section of the horn antenna 1 of FIG. 1 seen in the primary direction of emission HA.

The embodiment according to FIG. 3 differs essentially such that any centering of the filling 7 in reference to the antenna horn 3, particularly in reference to the feed device 5 embodied as a hollow conductor, is not achieved by an O-ring arranged in a groove projecting outwardly but by an attachment 75 provided circumferentially at the filling 7. Such an attachment 75 can also yield a centered alignment of the filling 7 in reference to the feed device 5, by which a defined air gap 17 can be adjusted over the entire length of the filling 7 between the filling 7 and the antenna horn 3. Compared to a circumferential groove with an O-ring arranged therein, an appropriate attachment 75 leads to reduced production expenses, thus with lower costs a comparably good result can be yielded.

FIG. 4 shows as an example the propagation of the electromagnetic waves inside a horn antenna 1. The propagation shown in FIG. 4 is illustrated using an example of a horn antenna 1 with a section at the front according to FIG. 1 and a rear section according to FIG. 3. As discernible from the illustration of FIG. 4, at the O-rings 91, 92 as well as the attachment 75 only minor interferences of the propagation of the electromagnetic waves are discernible inside the horn antenna 1, so that the effect according to the invention is very well achieved.

### LIST OF REFERENCE NUMBERS:

1 horn antenna
3 antenna horn
5 direction of feed
7 filling
9 seal
11 step
12 collar
15 centering ring
16 centering brace
17 air gap
19 exposed area
31 first groove of the antenna horn
32 second groove of the antenna horn
33 third groove of the antenna horn
71 first groove of the filling
72 second groove of the filling
75 attachment
91 first O-ring
92 second O-ring
HA primary direction of emission
R radial direction
V extension

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A horn antenna for a radar measuring device, comprising a radar level gauge, with an antenna horn emitting at the front in a primary direction of emission, a feed device at the rear, and a filling, which at least partially fills the horn antenna and seals it at the front, with between the filling and the antenna horn at least one seal being arranged, wherein the seal is arranged in a radial direction perpendicular in reference to the primary direction of emission of the horn antenna at least partially outside the antenna horn or an extension of the antenna horn.

2. The horn antenna according to claim 1, wherein the seal is embodied as an O-ring.

3. The horn antenna according to claim 1, wherein the seal is arranged in a groove.

4. The horn antenna according to claim 1, wherein the antenna horn comprises, at least in the proximity of the seal, an attachment pointing outwardly in the radial direction.

5. The horn antenna according to claim 4, wherein the attachment is embodied as a step projecting outwardly in the radial direction, comprising a circumferential collar and/or a circumferential groove extending in the primary direction of emission.

6. The horn antenna according to claim 1, wherein the filling comprises, in the proximity of the seal, a groove for at least partially accepting the seal.

7. The horn antenna according to claim 1, wherein a circumferential centering ring is arranged between the antenna horn and the filling.

8. The horn antenna according to claim 7, wherein the centering ring is embodied as an O-ring.

9. A horn antenna according to claim 7, wherein the centering ring is arranged in a circumferential third groove of the antenna horn.

10. The horn antenna according to claim 1, wherein at least two O-rings are arranged in a frontal section in the primary direction of emission and one centering ring in a rear section in a primary direction of emission.
